(19) United States
(12) Patent Application Publication
(10) Pub. No.: US 2026/0082279 A1
(43) Pub. Date: Mar. 19, 2026

(54) METHOD AND APPARATUS FOR SETTING ALLOWABLE POSITION ERROR IN TERMINAL LOCATION PREDICTION-BASED MESSAGE GENERATION METHOD

(71) Applicant: LG ELECTRONICS INC., Seoul (KR)

(72) Inventors: Heejin KIM, Seoul (KR); Hanbyul SEO, Seoul (KR)

(21) Appl. No.: 19/106,509

(22) PCT Filed: Aug. 29, 2023
(86) PCT No.: PCT/KR2023/012779

§ 371 Date: Feb. 25, 2025

(30) Foreign Application Priority Data
Aug. 30, 2022 (KR) 10-2022-0109401

(51) Int. Cl. H04W 28/18; H04W 4/029; H04W 28/02

(52) U.S. Cl. CPC H04W 28/18; H04W 28/0226; H04W 4/029

(57) ABSTRACT

Provided are a method by which a first device performs wireless communication, and an apparatus supporting same. The method may comprise the steps of: transmitting, to a second device, a first message including first state information of the first device; generating a second message including second state information of the first device, on the basis of a difference between a predicted state of the first device, determined on the basis of the first state information, and a current state of the first device being greater than or equal to a threshold value; and transmitting the second message to the second device. For example, the threshold may be set on the basis of at least one of (i) a service of the first device or (ii) a state of the first device.

### CROSS-REFERENCE TO RELATED APPLICATIONS

This application is the National Stage filing under 35 U.S.C. 371 of International Application No. PCT/KR2023/012779 filed on Aug. 29, 2023, which claims the benefit of Korean Patent Application No. 10-2022-0109401 filed on Aug. 30, 2022, which is hereby incorporated by reference herein in its entirety.

### TECHNICAL FIELD

This disclosure relates to a wireless communication system.

### BACKGROUND

Sidelink (SL) communication is a communication scheme in which a direct link is established between User Equipments (UEs) and the UEs exchange voice and data directly with each other without intervention of a base station. SL communication is under consideration as a solution to the overhead of a base station caused by rapidly increasing data traffic. Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (MTC), Ultra-Reliable and Low Latency Communication (URLLC), and so on, may be referred to as a new radio access technology (RAT) or new radio (NR). Herein, the NR may also support vehicle-to-everything (V2X) communication.

### SUMMARY

In one embodiment, provided is a method for performing wireless communication by a first device. The method may comprise: transmitting, to a second device, a first message including a first state information of the first device; generating a second message including a second state information of the first device, based on a difference between a predicted state of the first device determined based on the first state information and a present state of the first device being greater than or equal to a threshold value; and transmitting, to the second device, the second message. For example, the threshold value is configured based on at least one of (i) a service of the first device or (ii) a state of the first device.

In one embodiment, provided is a first device configured to perform wireless communication. The first device may comprise: at least one transceiver; at least one processor; and at least one memory connected to the at least one processor and storing instructions. For example, the instructions, based on being executed by the at least one processor, cause the first device to perform operations comprising: transmitting, to a second device, a first message including a first state information of the first device; generating a second message including a second state information of the first device, based on a difference between a predicted state of the first device determined based on the first state information and a present state of the first device being greater than or equal to a threshold value; and transmitting, to the second device, the second message. For example, the threshold value is configured based on at least one of (i) a service of the first device or (ii) a state of the first device.

In one embodiment, provided is a processing device configured to control a first device. The processing device may comprise: at least one processor; and at least one memory connected to the at least one processor and storing instructions. For example, the instructions, based on being executed by the at least one processor, cause the first device to perform operations comprising: transmitting, to a second device, a first message including a first state information of the first device; generating a second message including a second state information of the first device, based on a difference between a predicted state of the first device determined based on the first state information and a present state of the first device being greater than or equal to a threshold value; and transmitting, to the second device, the second message. For example, the threshold value is configured based on at least one of (i) a service of the first device or (ii) a state of the first device.

In one embodiment, provided is a non-transitory computer-readable storage medium recording instructions. For example, the instructions, based on being executed, cause a first device to perform operations comprising: transmitting, to a second device, a first message including a first state information of the first device; generating a second message including a second state information of the first device, based on a difference between a predicted state of the first device determined based on the first state information and a present state of the first device being greater than or equal to a threshold value; and transmitting, to the second device, the second message. For example, the threshold value is configured based on at least one of (i) a service of the first device or (ii) a state of the first device.

### BRIEF DESCRIPTION OF THE DRAWINGS

FIG. 1 shows a communication structure that can be provided in the 6G system, based on an embodiment of the present disclosure.

FIG. 2 shows an electromagnetic spectrum, based on an embodiment of the present disclosure.

FIG. 3 shows a general structure of a vulnerable road users awareness message (VAM).

FIG. 4 shows an example of a model in which predictions of location or risk level of the UE is performed.

FIG. 5 shows a method transmitting a message based on predicting a UE location by the UE, based on an embodiment of the present disclosure.

FIG. 6 shows a method transmitting a message based on predicting a UE location by the server, based on an embodiment of the present disclosure.

FIG. 7 shows a method for performing wireless communication by a first device, based on an embodiment of the present disclosure.

FIG. 8 shows a method for performing wireless communication by a second device, based on an embodiment of the present disclosure.

FIG. 9 shows a communication system 1, based on an embodiment of the present disclosure.

FIG. 10 shows wireless devices, based on an embodiment of the present disclosure.

FIG. 11 shows a signal process circuit for a transmission signal, based on an embodiment of the present disclosure.

FIG. 12 shows another example of a wireless device, based on an embodiment of the present disclosure.

FIG. 13 shows a hand-held device, based on an embodiment of the present disclosure.

FIG. 14 shows a vehicle or an autonomous vehicle, based on an embodiment of the present disclosure.

### DETAILED DESCRIPTION

In the present disclosure, “A or B” may mean “only A”, “only B” or “both A and B.” In other words, in the present disclosure, “A or B” may be interpreted as “A and/or B”. For example, in the present disclosure, “A, B, or C” may mean “only A”, “only B”, “only C”, or “any combination of A, B, C”.

A slash (/) or comma used in the present disclosure may mean “and/or”. For example, “A/B” may mean “A and/or B”. Accordingly, “A/B” may mean “only A”, “only B”, or “both A and B”. For example, “A, B, C” may mean “A, B, or C”.

In the present disclosure, “at least one of A and B” may mean “only A”, “only B”, or “both A and B”. In addition, in the present disclosure, the expression “at least one of A or B” or “at least one of A and/or B” may be interpreted as “at least one of A and B”.

In addition, in the present disclosure, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present disclosure may mean “for example”. Specifically, when indicated as “control information (PDCCH)”, it may mean that “PDCCH” is proposed as an example of the “control information”. In other words, the “control information” of the present disclosure is not limited to “PDCCH”, and “PDCCH” may be proposed as an example of the “control information”. In addition, when indicated as “control information (i.e., PDCCH)”, it may also mean that “PDCCH” is proposed as an example of the “control information”.

In the following description, ‘when, if, or in case of’ may be replaced with ‘based on’.

A technical feature described individually in one figure in the present disclosure may be individually implemented, or may be simultaneously implemented.

In the present disclosure, a higher layer parameter may be a parameter which is configured, pre-configured or pre-defined for a UE. For example, a base station or a network may transmit the higher layer parameter to the UE. For example, the higher layer parameter may be transmitted through radio resource control (RRC) signaling or medium access control (MAC) signaling.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

The 6G (wireless communication) system is aimed at (i) very high data rates per device, (ii) a very large number of connected devices, (iii) global connectivity, (iv) very low latency, (v) lower energy consumption for battery-free IoT devices, (vi) ultra-reliable connectivity, and (vii) connected intelligence with machine learning capabilities. The vision of the 6G system can have four aspects: intelligent connectivity, deep connectivity, holographic connectivity, and ubiquitous connectivity, and the 6G system can satisfy the requirements as shown in Table 1 below. In other words, Table 1 is an example of the requirements of a 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

6G systems can have key elements such as enhanced mobile broadband (eMBB), ultra-reliable low latency communications (URLLC), massive machine-to-machine communications (mMTC), AI-integrated communications, tactile internet, high throughput, high network capacity, high energy efficiency, low backhaul and access network congestion, and enhanced data security.

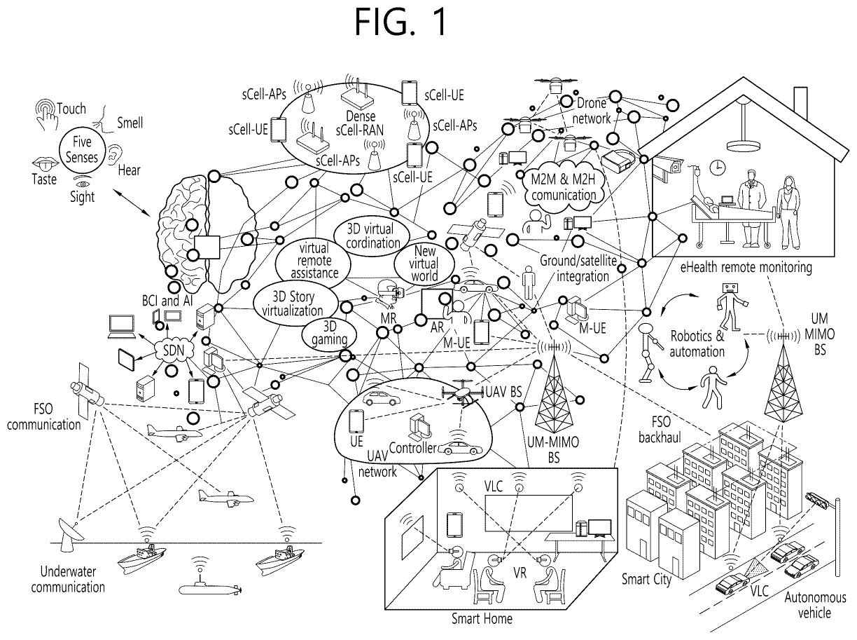

FIG. 1 shows a communication structure that can be provided in the 6G system, based on an embodiment of the present disclosure. The embodiment of FIG. 1 may be combined with various embodiments of the present disclosure.

6G systems are expected to have 50 times higher simultaneous radio connectivity than 5G radio systems. URLLC, a key feature of 5G, will become a more dominant technology in 6G communications, providing end-to-end delay of less than 1 ms. 6G systems will have much better volumetric spectral efficiency as opposed to the more commonly used area spectral efficiency. 6G systems will be able to offer very long battery life and advanced battery technologies for energy harvesting, so mobile devices will not need to be charged separately in a 6G system. New network characteristics in 6G may include the following.
Satellites integrated network: In order to provide a global mobile population, 6G is expected to be integrated with satellites. The integration of terrestrial, satellite, and airborne networks into a single wireless communication system is critical to 6G.
Connected intelligence: Unlike previous generations of wireless communication systems, 6G is revolutionary and will update the wireless evolution from “connected things” to “connected intelligence”. AI can be applied at each step of the communication process (or each step of signal processing, as we will see later).
Seamless integration wireless information and energy transfer: 6G wireless networks will transfer power to charge the batteries of devices such as smartphones and sensors. Therefore, wireless information and energy transfer (WIET) will be integrated.
Ubiquitous super 3D connectivity: Access to networks and core network functions from drones and very low Earth orbit satellites will make super 3D connectivity ubiquitous in 6G.

From the above new network characteristics of 6G, some common requirements may include.
Small cell networks: The idea of small cell networks was introduced in cellular systems to improve the received signal quality as a result of improved throughput, energy efficiency, and spectral efficiency. As a result, small cell networks are an essential characteristic for 5G and beyond 5G (5 GB) communication systems. Therefore, 6G communication systems will also adopt the characteristics of small cell networks.
Ultra-dense heterogeneous network: Ultra-dense heterogeneous networks will be another important characteristic of 6G communication systems. Multi-tier networks composed of heterogeneous networks will improve overall QoS and reduce costs.
High-capacity backhaul: Backhaul connectivity is characterized by high-capacity backhaul networks to support large volumes of traffic. High-speed fiber optics and free-space optics (FSO) systems can be a possible solution to this problem.
Radar technology integrated with mobile technology: High-precision localization (or location-based services) through communication is one of the features of 6G wireless communication systems. Therefore, radar systems will be integrated with 6G networks.
Softwarization and virtualization: Softwarization and virtualization are two important features that are fundamental to the design process in a 5 GB network to ensure flexibility, reconfigurability, and programmability. In addition, billions of devices may be shared on a shared physical infrastructure.

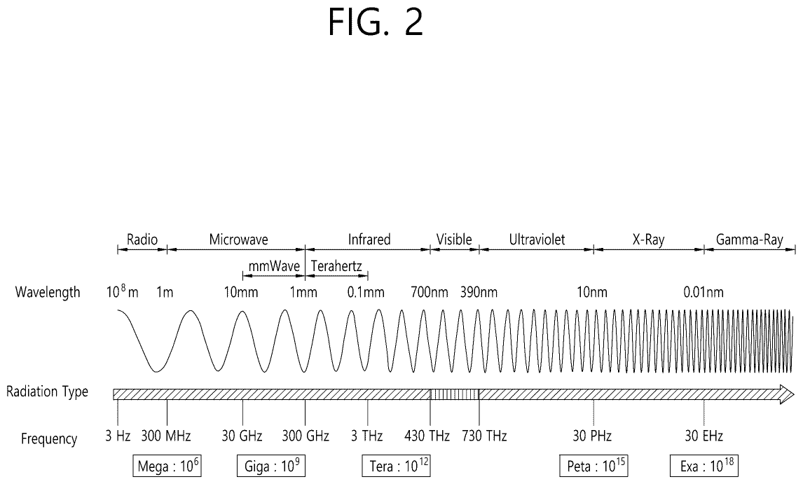

The following describes the key enabling technologies for 6G systems.
Artificial Intelligence: The most important and new technology to be introduced in the 6G system is AI. The 4G system did not involve AI. 5G systems will support partial or very limited AI. However, 6G systems will be AI-enabled for full automation. Advances in machine learning will create more intelligent networks for real-time communication in 6G. The introduction of AI in telecommunications can streamline and improve real-time data transfer. AI can use numerous analytics to determine how complex target tasks are performed, meaning AI can increase efficiency and reduce processing delays. Time-consuming tasks such as handover, network selection, and resource scheduling can be done instantly by using AI. AI can also play an important role in M2M, machine-to-human, and human-to-machine communications. In addition, AI can be a rapid communication in Brain Computer Interface (BCI). AI-based communication systems can be supported by metamaterials, intelligent structures, intelligent networks, intelligent devices, intelligent cognitive radios, self-sustaining wireless networks, and machine learning.
THz Communication (Terahertz Communication): Data rates can be increased by increasing bandwidth. This can be accomplished by using sub-THz communication with a wide bandwidth and applying advanced massive MIMO technology. THz waves, also known as submillimeter radiation, refer to frequency bands between 0.1 and 10 THz with corresponding wavelengths typically ranging from 0.03 mm-3 mm. The 100 GHz-300 GHz band range (Sub THz band) is considered the main part of the THz band for cellular communications. Adding the Sub-THz band to the mmWave band increases the capacity of 6G cellular communications. Of the defined THz band, 300 GHZ-3 THz is in the far infrared (IR) frequency band. The 300 GHz-3 THz band is part of the optical band, but it is on the border of the optical band, just behind the RF band. Thus, the 300 GHz-3 THz band exhibits similarities to RF. FIG. 2 illustrates an electromagnetic spectrum, according to one embodiment of the present disclosure. The embodiment of FIG. 2 may be combined with various embodiments of the present disclosure. Key characteristics of THz communications include (i) widely available bandwidth to support very high data rates, and (ii) high path loss at high frequencies, for which highly directive antennas are indispensable. The narrow beamwidth produced by highly directive antennas reduces interference. The small wavelength of THz signals allows a much larger number of antenna elements to be integrated into devices and BSs operating in this band. This enables the use of advanced adaptive array techniques that can overcome range limitations.
Large-scale MIMO Technology (Large-scale MIMO)
Hologram Beamforming (HBF, Hologram Bmeaforming)
Optical wireless technology
Free-space optical transmission backhaul network (FSO Backhaul Network)
Non-Terrestrial Networks (NTN)
Quantum Communication
Cell-free Communication
Integration of Wireless Information and Power Transmission
Integration of Wireless Communication and Sensing
Integrated Access and Backhaul Network
Big data Analysis
Reconfigurable Intelligent Surface (Reconfigurable Intelligent Surface)
Metaverse
Block-chain
Unmanned aerial vehicles (UAVs): Unmanned aerial vehicles (UAVs) or drones will be an important component of 6G wireless communications. In most cases, high-speed data wireless connectivity will be provided using UAV technology. BS entities are installed on UAVs to provide cellular connectivity. UAVs have certain features not found in fixed BS infrastructure, such as easy deployment, strong line-of-sight links, and controlled degrees of freedom for mobility. During emergencies, such as natural disasters, the deployment of terrestrial telecom infrastructure is not economically feasible and sometimes cannot provide services in volatile environments. UAVs can easily handle these situations. UAVs will be a new paradigm in wireless communications. This technology facilitates the three basic requirements of wireless networks, which are eMBB, URLLC, and mMTC. UAVs can also support many other purposes such as enhancing network connectivity, fire detection, disaster emergency services, security and surveillance, pollution monitoring, parking monitoring, accident monitoring, etc. Therefore, UAV technology is recognized as one of the most important technologies for 6G communications.
Autonomous Driving (Autonomous Driving, Self-driving): For complete autonomous driving, vehicle-to-vehicle communication is required to inform each other of dangerous situations, and vehicle-to-vehicle communication with infrastructure such as parking lots and traffic lights is required to check information such as the location of parking information and signal change times. Vehicle to Everything (V2X), a key element in building an autonomous driving infrastructure, is a technology that enables vehicles to communicate and share information with various elements on the road, such as vehicle-to-vehicle (V2V) and vehicle-to-infrastructure (V21) wireless communication, in order to perform autonomous driving. In order to maximize the performance of autonomous driving and ensure high safety, fast transmission speeds and low latency technologies are essential. In addition, in the future, autonomous driving will go beyond delivering warnings or guidance messages to the driver to actively intervene in vehicle operation and directly control the vehicle in dangerous situations, so the amount of information that needs to be transmitted and received will be vast, and 6G is expected to maximize autonomous driving with faster transmission speeds and lower latency than 5G.

For clarity of description, 5G NR is mainly described, but the technical idea according to an embodiment of the present disclosure is not limited thereto. Various embodiments of the present disclosure may also be applied to a 6G communication system.

Meanwhile, a transmission method of message in the current intelligent transport system (ITS) standard is as follows.

The transmission method of the message defined in the current ITS standard may be classified into periodic transmission and/or aperiodic transmission (e.g., event-triggered-based transmission) depending on the type of the message. At this time, the periodic transmission may basically mean that messages are generated/transmitted according to a (pre-) defined/configured message transmission period, and when the (pre-) defined/configured message generation/transmission triggering condition is satisfied, it may mean a message transmission method in which message generation/transmission is allowed at a specific time within that defined/configured period. That is, the message defined to be transmitted periodically may mean that the message generation/transmission should be performed according to the (pre-) defined/configured period even if an event corresponding to the (pre-) defined/configured message generation/transmission triggering condition does not occur, and this may mean that a time interval between the previous message transmission (e.g., Nth message transmission) and the next message transmission (e.g., (N+1)th message transmission) cannot be longer than the (pre-) defined/configured time period (e.g., the message generation/transmission period), regardless of whether an event corresponding to the message generation/transmission triggering condition occurs.

Meanwhile, a definition of the optional data field of the path history/prediction, etc. in the current ITS standard is as follows.

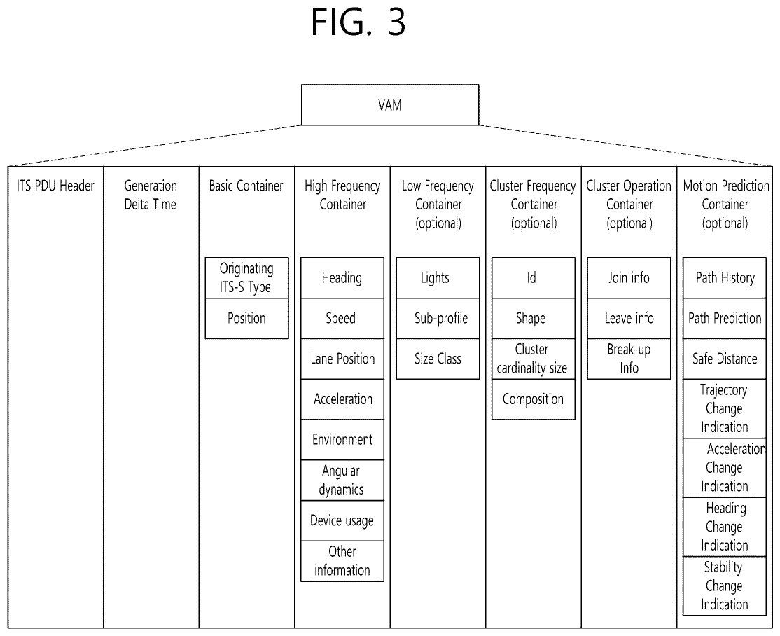

The message composition/format in the current ITS standard may be defined as classified into the mandatory container/data/field and the optional container/data/field. For example, in the case of the vulnerable road users awareness (VAM) defined for the purpose of the vulnerable road users (VRU) awareness basic service, it may be composed of containers as shown in FIG. 3 below, and each container may be composed of one or more data fields (DF). Additionally, each container/DF may be defined in the ITS standard as classified into the mandatory container/DF that must be included when transmitting message or the optional container/DF.

FIG. 3 shows a general structure of a vulnerable road users awareness message (VAM). For example, each container of the VAM may be composed one or more DFs, and each container/DF may be classified into the mandatory container/DF or the optional container/DF.

Meanwhile, as shown in the FIG. 3 above, in a message for VRU protection purposes such as VAM, a DF such as path history or path prediction may be included in the message and transmitted, and as shown in Table 2 below, in the current ITS standard, the path history/prediction DF may be expressed by one or more, but not more than 40, path points, and each path point may be composed of a path position, which is location information of a VRU path, and path delta time information, which informs at what point in time the path position information is information.

TABLE 2

| | |
|---|---|
| Description | This DF represents the VRU's recent movement over some past time and/or |
| | distance. It consists of a list of path points, each represented as DF |
| | PathPoint. The list of path points may consist of up to 40 elements (see |
| | further details in clause 7.3.6). |
| Insert in VAM | Optional. |
| Data setting and | The DF shall be presented as specified in ETSI TS 102 894-2 [7] A117 |
| presenting | pathHistory. It consists of up to 50 PathPoint. as specified in ETSI TS 102 |
| requirements | 894-2 [7] A118. Each PathPoint consists of pathPosition (A109) and an |
| | optional pathDeltaTime (A47) with granularity of 10 ms. |

However, in the ITS standard, it does not specify detailed message operation method, such as under what condition (e.g., location of the VRU, surrounding conditions, communication environment, etc.) the optional container/DF should be transmitted by being included in the message, and for DFs composed of one or more path points, such as path history/prediction, there is no definition of how the number of path points that should be included (or may be included) in the message is adjusted/determined based on what condition/criteria. Here, the size of the generated/transmitted VRU message may vary depending on whether the optional DF/container such as the path history/prediction DF is included in the VRU message, or how many path points are transmitted by including it in that message when transmitting the path history/prediction DF by including it in the VRU message. Furthermore, since the size of the message transmitted by the VRU may affect the amount of data traffic transmitted by the VRU UE to the counterpart VRU/vehicle/RSU/base station, etc., and/or the transmission power/electricity/time length required for the VRU UE to transmit the message, it may be desirable to compose the message in a way that can reduce the size of the message of data transmitted by the VRU (or containing information about the VRU), if possible.

Meanwhile, in the current ITS standard, a definition of role/state of the VRU is as follows.

The transmission method of the message defined in the current ITS standard may be classified into the periodic transmission and/or the aperiodic transmission (e.g., event-triggered-based transmission). At this time, the periodic transmission may basically mean that message is generated/transmitted depending on the (pre-) defined/configured message transmission period, and if the (pre-) defined/configured message triggering condition is satisfied, the message generation/transmission may be performed within a time duration within the configured period. For example, according to ETSI ITS standard (ETSI TS 103 300-3), for the VAM message, if the VRU UE is in the VRU-ACTIVE-STANDALONE state and one or more conditions in Table 3 below are satisfied, the VAM message generation/transmission may be triggered.

TABLE 3
1) The time elapsed since the last time the individual VAM was transmitted exceeds T_GenVamMax.
2) The Euclidian absolute distance between the current estimated position of the reference point of the
VRU and the estimated position of the reference point lastly included in an individual VAM exceeds a pre-
defined threshold minReferencePointPositionChangeThreshold.
3) The difference between the current estimated ground speed of the reference point of the VRU and
the estimated absolute speed of the reference point of the VRU lastly included in an individual VAM exceeds
a pre-defined threshold minGroundSpeedChangeThreshold.
4) The difference between the orientation of the vector of the current estimated ground velocity of the
reference point of the VRU and the estimated orientation of the vector of the ground velocity of the reference
point of the VRU lastly included in an individual VAM exceeds a pre-defined threshold
minGroundVelocityOrientationChangeThreshold.
5) The VRU has determined that there is a difference between the current estimated trajectory
interception probability with vehicle(s) or other VRU(s) and the trajectory interception probability with
vehicle(s) or other minTrajectoryInterceptionProbChangeThreshold.
6) The originating ITS-S is a VRU in VRU-ACTIVE-STANDALONE VBS state and has decided to
join a cluster after its previous individual VAM transmission.
7) VRU has determined that one or more new vehicles or other VRUs have satisfied the following
conditions simultaneously after the lastly transmitted VAM:
coming closer than minimum safe lateral distance (MSLaD) laterally;
coming closer than minimum safe longitudinal distance (MSLoD) longitudinally;
coming closer than minimum safe vertical distance (MSVD) vertically.

Meanwhile, in the ETSI ITS standard (ETSI TS 103 300-3), the role/state of the VRU UE is defined as shown in Table 4 below, where the VRU UE may transition to the VRU_ROLE_OFF state when it determines that it is in a zero-risk area (e.g., located inside a car/bus/building), and in this state, the VRU may not perform any transmission/reception of the VAM which is a VRU message.

TABLE 4

| | | Valid VRU | Valid VRU | |
|---|---|---|---|---|
| VRU role | Specification | profiles | types | Additional explanation |
| VRU_ROLE_ON | The device user is | ALL | ALL | The VBS state should be |
| | considered as a VRU. | | | changed according to the |
| | Based on information | | | condition of VRU device user |
| | received from VRU | | | as notified by the VRU profile |
| | profile management | | | Management entity. The VRU |
| | entity, the VBS shall | | | device can send VAMs, |
| | check the type of VRU | | | receive VAMs, or both while |
| | and the profile of VRU. | | | checking the position of VRU |
| | It shall also handle the | | | device user through the PoTi |
| | VBS clustering state | | | entity. Except for VRUs of |
| | and provide services to | | | profile 3, it may execute the |
| | other entities, as | | | VRU clustering functions (see |
| | defined in clause 5. | | | clause 5). |
| VRU_ROLE_OFF | The device user is not | ALL | ALL | The VRU is located in a “zero- |
| | considered as a VRU. | | | risk” geographical area, for |
| | The VRU device shall | | | example in a bus, in a |
| | neither send nor receive | | | passenger car, etc. |
| | VAMs. | | | The VBS remains operational |
| | | | | in this state to monitor any |
| | | | | notification that the role has |
| | | | | changed to VRU_ROLE_ON. |

Furthermore, as shown in Table 5 below, according to the ETSI ITS standard (ETSI TS 103 300-3), if the VRU UE determines that it is in a low-risk area, it may transition its state to VRU-PASSIVE, and in this case, the VRU UE may not perform the VAM message transmission. Therefore, in summary of the above, although the VAM is defined as a message that is transmitted periodically in the current ETSI ITS standard, it may be supported/allowed in the standard that the VRU UE does not transmit the message if the VRU is in the zero/low-risk area.

TABLE 5

| | | Valid VRU | Valid VRU | |
|---|---|---|---|---|
| VBS State | Specification | profiles | types | Additional explanation |
| VRU-IDLE | The device user is not | ALL | ALL | The VRU role as defined in |
| | considered as a VRU | | | clause 4.2 is |
| | | | | VRU_ROLE_OFF. |
| VRU-ACTIVE- | VAMs or CAMs (in | ALL | VRU-St, | In this state a VRU ITS-S may |
| STANDALONE | case of VRU Profile 2) | | VRU-Tx | indicate an intention to join a |
| | are transmitted with | | | cluster, or indicate that it has |
| | information related to | | | just left a cluster. |
| | only that VRU. | | | |
| VRU-ACTIVE- | VAMs are transmitted | VRU | VRU-St | |
| CLUSTER- | and include a container | profile 1, | | |
| LEADER | with specific data | VRU | | |
| | elements related to the | profile 2 | | |
| | cluster | | | |
| VRU-PASSIVE | The VRU device does | ALL | VRU-St, | The VRU is member of a |
| | not transmit VAMs | except | VRU-Tx | cluster or located in a low-risk |
| | | VRU | | geographical area defined in |
| | | profile 3 | | clause 3.1 (see FCOM03 in |
| | | | | ETSI TS 103 300-2 [1]). |
| | | | | In the case the area rules |
| | | | | authorize the traffic of motor |
| | | | | vehicles, the VBS can also |
| | | | | remain in VRU-ACTIVE- |
| | | | | STANDALONE VBS state |
| | | | | and increase the periodicity of |
| | | | | the VAMs. |

Meanwhile, Ericsson's contributions (A-170134) published in 5GAA in 2017 includes the followings.
The current ITS standard only considers a broadcast transmission of CAM message, and the message is transmitted periodically (even without special events).
If the UE transmits the CAM message using a Uu link, it is efficient to not periodically transmit the CAM message, but for the transmission UE (or, server/cloud) to predict the location of the UE and for the transmission UE to perform uplink (UL) transmission of the message to the server/cloud (or for the server to perform downlink (DL) transmission (or forward) of the message for the transmission UE to the reception UE) only when the location of the transmission UE exceeds a (pre-) configured specific threshold value. This may have the effect of reducing UL and/or DL traffic.
That is, in terms of specification changes, the maximum transmission period (e.g., 1 second) of the CAM defined in the current ITS standard may be deleted, and a new message generation triggering condition may be added, where a message is triggered if the location of the transmission UE predicted by the transmission UE (or server/cloud) differ from the current actual location of the transmission UE by a (pre-) configured specific threshold value.

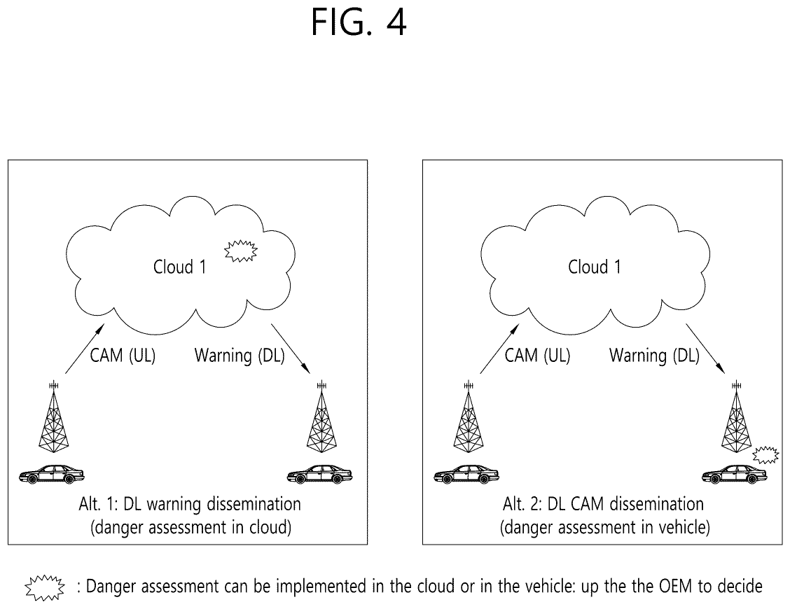

FIG. 4 shows an example of a model in which predictions of location or risk level of the UE is performed. Specifically, (a) of FIG. 4 shows an example of a model in which a prediction of the location and/or collision/accident risk of a transmission UE (or a reception UE) is performed in a server/cloud, and (b) of FIG. 4 shows an example of a model in which a UE directly performs prediction of its own location and/or collision/accident risk.

Meanwhile, according to the conventional technology above, if the transmission of CAM messages, etc. to the server of the UE is performed only periodically, data traffic may increase in the communication between the UE and the server, which may result in degradation of network and server performance or increased load on the server, which may cause service provision to be interrupted. In addition, according to the conventional technology above, even if the transmission of CAM messages, etc. to the server of the UE is performed only when a specific threshold value is exceeded based on the UE location prediction, if the specific threshold value is not configured flexibly according to the state of the UE, etc., problems such as increased data traffic may occur as described above, so the range of the specific threshold value needs to be specifically defined.

In the present disclosure, a method for configuring an allowable position error level used when a transmitter (e.g., a transmission UE and/or a server/cloud/central ITS-station/mobile edge computing (MEC) in long range/short range communication) determines whether to generate a message based on a position prediction of the UE, and a device supporting the same are proposed.

For example, as shown in FIG. 4 above, when determining whether to generate message based on location prediction of the UE in Uu V2X, the following two scenarios may be considered depending on who makes the prediction about the location of the UE.
Scenario 1 (when the UE location prediction is performed on the transmission UE side): For example, the transmission UE may predict its own location based on information about itself (e.g., location and/or velocity and/or acceleration and/or heading, etc.) included in the message (e.g., CAM/DENM/VAM/BSM/PSM) it most recently transmits. For example, if the difference between its predicted own location and its actual current location is greater than or equal to a (pre-) configured allowable position error level, the transmission UE may generate a new message including its (latest) information and transmit it to the server/cloud.
Scenario 2 (when the UE location prediction is performed on the server/cloud/MEC side): For example, the server/cloud/central ITS-station/MEC may predict the location of the UE based on information about the UE (e.g., location and/or velocity and/or acceleration and/or heading, etc.) included in the most recent message (e.g., CAM/DENM/VAM/BSM/PSM) received from that UE. For example, if the difference between the predicted location of the UE and the actual current location of the UE is greater than or equal to a (pre-) configured allowable position error level, the server/cloud may transmit the message including (latest) information about the UE to UEs located around the UE.

For example, as the scenario 1 or the scenario 2 above, in the case of the method for triggering the message generation/transmission based on the location prediction of the UE, unlike the method for periodic generation/transmission of message defined in current ITS standards (e.g. EN 302 637-2, EN 302 637-3, TS 103 300-3 or J2945/9), even after a certain time duration/period (e.g., the maximum value between the time of the previous message generation and the time of the next message generation) has elapsed, if the difference between the actual location of the UE and the predicted location of the UE is within the allowable error level, a new message generation may not be performed.

Additionally, for example, in the case of the direct communication, the same operation as scenario 1 in Uu V2X described above may be considered. That is, for example, the location prediction of the UE may be performed on the transmission UE side, and the transmission UE may predict its own location based on the information about itself (e.g., location and/or velocity and/or acceleration and/or heading, etc.) included in the message (e.g., CAM/DENM/VAM/BSM/PSM) it most recently transmits. At this time, for example, if the difference between its predicted location and its actual current location is greater than or equal to the (pre-) configured allowable position error level, the transmission UE may generate a new message including its (latest) information, and perform unicast/groupcast/broadcast transmission to the (surrounding) reception UE through the direct communication.

### Proposal 1.

In the method for generating/transmitting the message based on the location prediction of the UE, the transmitter may predict the location of the UE, and a message may be generated/transmitted only if the difference between the predicted location of the UE and the actual location of the UE exceeds the allowable position error level. At this time, for example, the allowable position error level considered by the transmitter may be determined based on one or more of the followings. Additionally, for example, the allowable position error level may be a value that can be configured/changed (semi-) statically/dynamically at the transmitter (or receiver) depending on the service, region, area, road, UE, and situation (that the UE/server is in).

For example, the transmitter may mean an entity predicting the location of the UE (or determining whether to generate message based on the prediction), and the receiver may mean an entity receiving the generated message from the transmitter. For example, in the case of the scenario 1 related to the Uu V2X described above, the transmission UE may be interpreted as the transmitter, and the server/cloud (or reception UE) may be interpreted as the receiver. For example, in the case of the scenario 2 related to the Uu V2X described above, the server/cloud may be interpreted as the transmitter, and the reception UE (which receives the message through DL) may be interpreted as the receiver.

Meanwhile, the contents of the proposal 1 in the present disclosure may also be applied identically/similarly to a case where a message is transmitted through the direct communication (or short-range communication) using communication technologies such as LTE-V2X, NR-V2X, IEEE 802.11p, ITS-G5, etc. In this case, for example, the contents of the proposal 1 in the present disclosure may be applied by considering the transmission UE as a transmitter and/or the reception UE as a receiver.
(1) The allowable position error which is configured according to a type of service that the transmission (and/or reception) UE wants to receive or the related quality of service (QoS)/requirements

For example, an allowable error in the safety-related service/unified communication (UC) may be configured smaller (or greater) than an allowable error in the non-safety-related service/UC.

For example, the higher the priority of a service related to a transmission (e.g., the smaller the ProSe Per-Packet Priority (PPPP) value), the smaller (or greater) an allowable error may be configured.

For example, an allowable error in the awareness/warning service may be configured smaller (or greater) than an allowable error in other services.

For example, for a service with tight positioning accuracy requirement, an allowable error may be configured small.
(2) The allowable position error which is configured according to location of the transmission (and/or reception) UE or whether the transmission (and/or reception) UE is located in a predefined specific geographical area/location.

For example, if the message transmission (TX)/reception (RX) subscription based on zone/tile is performed, an allowable error may be configured according to whether the transmission and/or reception) UE is located in (or is planned to enter) the predefined specific zone/tile (e.g., a zone/tile with high accident frequency/high risk).

For example, if the transmission (and/or reception) UE is located in a high-risk area (or its surroundings), an allowable error may be configured small (or large).

For example, if the transmission (and/or reception) UE is a VRU (e.g., a pedestrian, a wheelchair, a bicycle, or kickboard, etc.) it may stop the message transmission (or reception) when entering/locating the low/zero risk area. Alternatively, for example, the message transmission may be continued but an allowable error may be configured large (compared to when locating in a low/zero risk area).

For reference, the high/low/zero risk area described above may be defined/classified as follows.
Examples of high-risk area: crosswalks, intersections, roads, shoulders, school zone, or accident-prone/risk areas (e.g., sharp curves, unmarked crosswalks, etc.) designated by load operators/local authorities, etc.
Examples of low/zero-risk area: when the UE holder enters/is located inside the building/vehicle, or when the pedestrian is located/driving on a sidewalk (e.g., sidewalk that is clearly separated from the roadway)
(3) The allowable position error which is configured according to the current (or predicted) velocity, acceleration, heading, or curve rotation angle (or radius) of the transmission (and/or reception) UE.

For example, the higher the current velocity/acceleration of the transmission (and/or reception) UE, the smaller (or greater) an allowable error is configured.

For example, the greater the change in the heading of the transmission (and/or reception) UE, the smaller (or greater) an allowable error is configured.

For example, the greater the curve rotation angle (or steering angle) of the transmission (and/or reception) UE, the smaller (or greater) an allowable error is configured.

For example, an allowable error may be configured small (or large) when a transmission (and/or reception) UE, which is a two-wheeled vehicle (e.g., motorcycle, bicycle or electric bicycle), enters a curve, and/or while turning a curve, and/or when exiting a curve.
(4) The number of (surrounding) UEs on the road (UE density)

For example, the surrounding UEs considered here may mean the same type of UEs (e.g., vehicle/pedestrian/bicycle, etc.) as the transmission (and/or reception) UE, or may comprehensively mean the types of identical/different UEs that are at risk of collision with each other. For example, when determining the allowable error of the prediction for the vehicle's location, the number of surrounding UEs may be calculated by considering not only surrounding vehicles but also surrounding bicycles/pedestrians (who may have the potential to collide/accident with the vehicle).

For example, since the risk of accidents may be higher when the UEs are densely packed (compared to other cases), it may be helpful to make the allowable error in prediction smaller than when the UE density is low.
(5) The allowable error which is configured according to the (maximum/minimum) absolute/relative speed/direction of surrounding UEs.

For example, it may be helpful to configure a smaller (or larger) allowable error when surrounding UEs (with potential risk of accident/collision) and/or (target) reception UE(s) have a large difference in driving speed (even if they are driving in the same direction), rather than when they are driving in the same direction at nearly the same speed.

For example, it may be helpful to configure a smaller (or larger) allowable error when UEs (with potential risk of accident/collision) and/or (target) reception UE(s) are driving in different directions (especially facing each other from opposite directions) rather than in the same direction.
(6) The allowable error which is configured according to a type of roads (e.g., dedicated road for automobiles, highways, general road (with relatively low relative/absolute driving speed compared to the highways), sidewalk, intersection, crosswalk, or school zone, etc.) where the transmission (and/or reception) UE is driving

For example, when the UE is driving on the road where high-speed driving is allowed, the allowable error may be configured smaller (or larger) (compared to when driving on the road where only low-speed driving is allowed).

For example, the allowable error may be configured differently depending on whether the lane in the direction in which the UE is driving and the lane in the opposite direction on the road where the UE is driving are divided by a center divider/dividing bar or whether the road is divided by a sidewalk/roadway by a divider/dividing bar. For example, in the case where it is divided by the central divider/dividing bar described above, the allowable error may be configured larger than in the case where it is not.

For example, especially when the transmission (and/or reception) UE is a VRU (e.g., pedestrian, wheelchair, bicycle, or kickboard, etc.), the allowable error may be configured smaller (or larger) when driving on a shoulder and/or crosswalk and/or alley and/or school zone, etc., where the vehicle must drive together with the vehicle than when driving on a sidewalk (which is divided from the roadway).
(7) The allowable error which is configured according to maximum/minimum driving speed allowed on the road/area where the transmission (and/or reception) UE is driving.
(8) The allowable error which is configured according to type/mode of the transmission (and/or reception) UE

For example, the allowable error may be configured smaller (or larger) when the UE's type is a VRU (pedestrian, wheelchair, motorcycle, (electric) bicycle, or kickboard, etc.) than when the UE's type is a vehicle.

For example, different allowable error may be configured for each mode/profile of the VRU.

For example, in the case of a power sensitive device (especially, the lower the remaining/maximum battery capacity of a pedestrian UE (e.g., a smartphone) or a transmission (and/or target reception) UE), the allowable error may be configured to be smaller (or larger).

For example, the allowable error may be configured smaller (or larger) for the type of the UE (or VRU profile) with higher maximum/average speed/acceleration that can be driven.

For example, the smaller the size/volume of the type of the UE (or VRU profile), the smaller (or larger) the allowable error may be configured.

For example, the larger the vertical inclination of the UE during curve driving, the smaller (or larger) the allowable error may be configured.

For example, the lower the regularity of driving patterns/directions/attributes for the type of the UE (i.e., UE that have more random driving patterns/directions/attributes (higher randomness of driving patterns/directions/attributes) or may have lower prediction accuracy for driving patterns/directions/attributes) or VRU profile, the smaller (or larger) the allowable error may be configured.

For example, in any one of the embodiments described above, difference between the vehicle and VRU and/or between VRU modes may be defined by the UE size/volume, maximum velocity/acceleration, driving characteristics (e.g., the degree of vertical inclination of the UE when driving curve), (total/remaining) battery capacity (i.e., the degree of need for power saving operation), the degree of fatality/injury in the event of an accident, or the regularity of driving patterns/directions/attributes (e.g., while vehicles are expected to drive along a configured velocity/lane/road, pedestrians are more likely (than vehicles) to suddenly change direction while walking, suddenly run while walking, or walk in a zigzag pattern, so driving patterns/directions/attributes of the pedestrians may be more difficult to predict/stereotype than those of vehicles).

For reference, according to ETSI ITS TS 103 300-2 (functional architecture and requirements definition release 2), the current VRU mode/classification criteria may be as shown in Table 6 below.

TABLE 6
Profile classification parameters:
Maximum and average (typical) Speed values (may be with its standard
deviation)
Minimum and average (typical) communication range: The communication
range is calculated based on the assumption that an awareness time of
5 seconds is needed to warn/act on the traffic participants
Environment e.g., type of area (urban, sub-urban, rural, highway)
Average Weight and standard deviation
directivity/trajectory ambiguity: give the level of confidence we may have
in the predictability of the behaviour of the VRU in its movements
NOTE: These parameters are not dynamic parameters maintained in
internal tables, but indications of typical values to be used to classify
the VRUs and evaluate the behaviour of a VRU belonging to a specific
profile.

Meanwhile, based on this, VRU may be defined by classifying it into four groups as shown in Table 7 below. For example, the profile/mode of the VRU (or UE) described above may be the same as the VRU profile defined/assumed in ETSI ITS TS 103 300-2 and ETSI ITS TS 103 300-3.

TABLE 7
VRU Profile 1 - Pedestrian. Typical VRUs in this profile: pedestrians, i.e. road users not using a
mechanical device for their trip. It includes for example pedestrians on a pavement, but also children, prams,
disabled persons, blind persons guided by a dog, elderly persons, persons walking beside their bicycle.
VRU Profile 2 - Bicyclist. Typical VRUs in this profile: bicyclists and similar e.g. light vehicles
riders, possibly with an electric engine. It includes bicyclists, but also wheelchair users, horses carrying a
rider, skaters, e-scooters, personal transporters, etc.
VRU Profile 3 - Motorcyclist. Typical VRUs in this profile: motorcyclists, which are equipped with
engines that allow them to move on the road. It includes users (driver and passengers, e.g. children and
animals) of Powered Two Wheelers (PTW) such as mopeds (motor scooters), motorcycles or side-cars.
VRU Profile 4 - Animals presenting a safety risk to other road users. Typical VRUs in this profile:
dogs, wild animals, horses, cows, sheep, etc. Some of these VRUs might have their own ITS-S (e.g. dog in a
city or a horse) but most of the VRUs in this profile will not be able to send the VAM and only be indirectly
detected, especially wild animals in rural areas and highway situations.

### Proposal 2.

As in scenario 2 described above, if the server/cloud performs the location prediction (or, the determination on whether to generate a message based on the prediction) of the UE, the server/cloud may configure a large allowable error (compared to other cases) if the DL traffic size or the congestion of the DL channel exceeds a certain level (for the purpose of DL traffic load management).

For example, the operation of the proposal 2 in the present disclosure may be interpreted as being affected by the number of surrounding UEs (e.g., the condition (4) of the proposal 1 above), the type of service (or the type/size of message) (e.g., the condition (1) of the proposal 1 above), or the method of determining a UE for receiving a message in DL (e.g., a method of configuring a Tx/Rx tile size in tile-based geo-cast).

### Proposal 2-1.

As in scenario 1 described above, if the transmission UE performs location prediction (or, determines whether to generate a message based on the prediction) and the server/cloud transmits/forwards the message received from the transmission UE to (surrounding) UEs through DL, the server/cloud may indicate the allowable error that the UE should consider by considering the current uplink (UL) traffic load. That is, for example, if the UL traffic load of the server/cloud is greater than or equal to a specific threshold level or the message/computation processing capacity that can be processed simultaneously in the server/cloud is greater than or equal to a specific threshold level, the server/cloud may increase the allowable error of the UL UE location prediction more than before (when the UL traffic load of the server/cloud is less than or equal to a specific threshold level or the message/computation processing capacity that can be processed simultaneously in the server/cloud is less than or equal to a specific threshold level), and inform the transmission UE of information about the increased allowable error level.

### Proposal 3.

In direct communication (e.g., LTE/NR sidelink, ITS-G5, or IEEE 802.11p-based short range communication), when determining whether to generate a message based on the location prediction of the UE, the transmission UE may configure a large allowable error (compared to other cases) when the congestion level (e.g., channel busy ratio (CBR)) of the packet transmission resource (e.g., channel/carrier/resource pool/bandwidth part) is greater than or equal to a specific level. In this case, for example, the effect of reducing the frequency/number of message generations may be expected.

### Proposal 4.

The server/cloud/reception UE may configure different allowable error level in the location prediction of the UE that transmits the data according to the strength/quality of the reception signal related to the data/packet it received or the success/probability of reception/decoding of previous data/packet.

For example, in the case of data transmitted from the UE (or server) with a low probability of successful reception/decoding of UL data by the server due to low quality/stability of the UL (or server-to-server communication) link, a lower allowable error may be configured compared to a transmission UE (or the transmission side in the server-to-server communication) that transmits data through a UL link with high quality/stability (taking into account the probability of data packets that fail to be transmitted/received in UL communication between the UE and the server (or server-to-server communication)). At this time, for example, the reception signal strength/quality of UL (or transmitted and received between servers) data or the success/probability of UL (or transmitted and received between servers) data reception/decoding may be determined based on the strength/quality of the reception signal measured from the reference signal transmitted together with UL (or, transmitted and received between servers), or the number of (consecutive) ACK/NACK occurrences for UL transmission (or transmitted and received between servers) packets, or the packet reception success rate (e.g., packet error rate (PER)). Additionally, for example, in order to implement the method described in the examples above, the server/cloud receiving data from the transmission UE (or server transmitting data in server-to-server communication) may need to inform the transmission UE (or server) of 1) the reception signal strength/quality related to the packets it received, 2) the number of times/whether/probability (e.g., PER) of successful packet reception/decoding measured/calculated during a specific time duration, or 3) information for the allowable position error level that the transmission UE (or the server) will consider in prediction-based message generation after the current point in time (adjusted/calculated based on 1) and/or 2) above) (e.g., the absolute value of the error level or the offset value compared to the previous error level, etc.).

For example, in the case of packets transmitted from a counterpart UE having low link quality/stability in direct communication (e.g., sidelink communication) and thus low packet reception/decoding success probability, it may be possible to allowed for a lower allowable position error compared to packets exchanged between UEs with high quality/stability (for the purpose of increasing the frequency/number of data occurrences by taking into account the probability of data packets failing to be transmitted/received in direct communication between UEs). For example, the above operations may be effective (or may be helpful to improve performance) especially in unicast or groupcast (using automatic repeat request (ARQ)).

For example, in the case of direct (sidelink) communication based on LTE/NR V2X, the reception signal strength/quality of packets transmitted between UEs may be measured using a reference signal transmitted together with the physical sidelink control channel (PSCCH)/physical sidelink shared channel (PSSCH) (or, physical sidelink feedback channel (PSFCH)), sidelink synchronization signal block (S-SSB), etc.

For example, when the SL channel state information (CSI) for a sidelink transmission packet transmission link is above/below a (preconfigured) specific threshold level and/or the reference signal received power (RSRP)/reference signal received quality (RSRQ) is below a (preconfigured) specific threshold level, the allowable error level applied to the prediction-based message generation rule in the communication between the transmission and reception UEs may be configured relatively lower (compared to the case where the SL CSI is below/above a (preconfigured) specific threshold level and/or the RSRP/RSRQ is above a (preconfigured) specific threshold level). For example, in order to implement the operations above, the reception UE may report its measured SL CSI and/or RSRP/RSRQ to the transmission UE, or may inform the transmission UE of the allowable position error level information (e.g., the absolute value of the error level or the offset value compared to the previous error level) that the transmission UE should consider in prediction-based message generation after the current point in time (calculated based on the SL CSI and RSRP/RSRQ that the reception UE measured).

If the number of (consecutive) NACK (or DTX) occurrences for sidelink transmission packets is greater than or equal to a (preconfigured) threshold, the frequency of (consecutive) SL RLF occurrences is greater than or equal to a (preconfigured) threshold, and/or the reception/decoding success probability (e.g., PER) of sidelink transmission packets is less than or equal to a (preconfigured) threshold, the allowable position error level applied to the prediction-based message generation rules in communication between the transmission and reception UEs may be configured relatively lower (compared to cases where the number of (consecutive) NACK (or DTX) occurrences is less than or equal to the (preconfigured) threshold, the frequency of (consecutive) SL RLF occurrences is less than or equal to the (preconfigured) threshold, and/or the reception/decoding success probability (e.g., PER) of sidelink transmission packets is greater than or equal to the (preconfigured) threshold). For example, in order to implement the operations above, the reception UE may report to the transmission UE the number of (consecutive) NACK (or DTX) occurrences, the frequency of (consecutive) SL radio link failure (RLF) occurrences, or the packet reception/decoding success probability (e.g., PER), or may inform the transmission UE of the allowable position error level information (e.g., absolute value of error level or offset value compared to previous error level) that the transmission UE should consider in prediction-based message generation after the current point in time (calculated based on the number of (consecutive) NACK (or DTX) occurrences, the frequency of (consecutive) SL RLF occurrences, or the packet reception/decoding success probability (e.g., PER)).

In the present disclosure, the contents of the present disclosure are described for the case where ITS message is transmitted through Uu link, but this does not limit the proposal of the present disclosure, and the proposal of the present disclosure may be applied in the identical/similar manner even when a message is transmitted through direct communication using a communication technology such as LTE-V2X, NR-V2X, IEEE 11p or ITS-G5.

Additionally, in the present disclosure, although the present disclosure mainly describes a method of generating/transmitting a message related to the transmission based on the location of the transmission UE predicted by the server/cloud/central-ITS station/MEC (or transmission UE), the proposal of the present disclosure may be identically/similarly applied to a method of generating/transmitting a message related to the transmission based on the absolute/relative value (e.g., the amount of change during a specific time duration) of the velocity/acceleration/heading of the transmission UE predicted by the server/cloud/central-ITS station/MEC (or transmission UE) and/or the risk of an accident/collision of the transmission UE. For example, if message generation/transmission is triggered only when the risk is greater than or equal to a specific threshold level based on the risk prediction of an accident/collision of a transmission UE, a method for configuring a specific threshold level which is a criterion for triggering message generation/transmission may be configured/determined in a manner identical to/similar to the proposed embodiments described above.

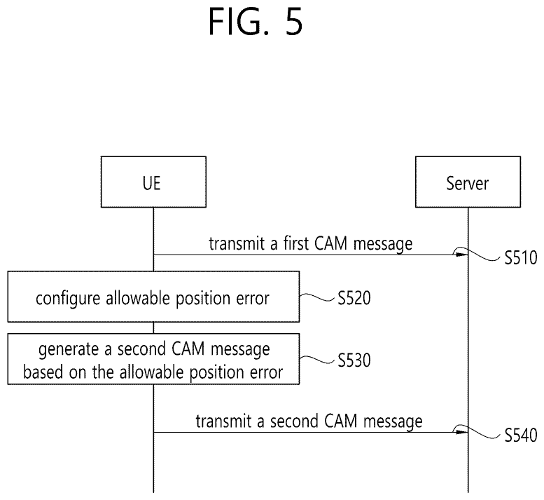

FIG. 5 shows a method transmitting a message based on predicting a UE location by the UE, based on an embodiment of the present disclosure. The embodiment of FIG. 5 may be combined with various embodiments of the present disclosure.

Referring to FIG. 5, In step S510, the UE may transmit a first CAM message including information related to its driving path or location to the server or cloud. For example, the UE may predict its driving path or location based on the information included in the first CAM message. In step S520, the UE may configure or determine an allowable position error. For example, the allowable position error may be used to compare the difference between the predicted driving path or location of the UE and the actual driving path or location of the UE. For example, the UE may configure or determine the allowable position error based on information related to the state of the UE. For example, the information related to the state of the UE may include information related to the type of service required by the UE, the area where the UE is located, or the driving state of the UE. For example, the allowable position error may be configured or determined as a flexible value based on one or more items included in the information related to the state of the UE. For example, the value of the allowable position error may be configured or determined to a smaller value as the probability of an accident occurring at the UE is determined to be higher based on information related to the state of the UE. In step S530, the UE may generate a second CAM message based on the difference between the predicted driving path or location of the UE and the actual driving path or location of the UE exceeding the allowable position error. For example, the second CAM message may include the latest driving information about the UE. In step S540, the UE may transmit the second CAM message to the server or cloud. For example, the smaller the value of the allowable position error is configured or determined, the higher the frequency of transmitting the second CAM message of the UE to the server or cloud. For example, the greater the value of the allowable position error is configured or determined, the lower the frequency of transmitting the second CAM message of the UE to the server or cloud.

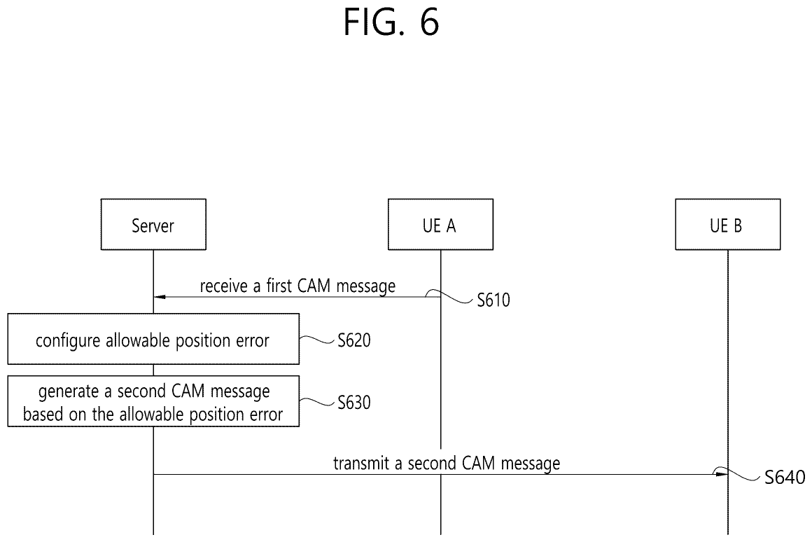

FIG. 6 shows a method transmitting a message based on predicting a UE location by the server, based on an embodiment of the present disclosure. The embodiment of FIG. 6 may be combined with various embodiments of the present disclosure.

Referring to FIG. 6, In step S610, the server may receive a first CAM message including information related to the driving path or location of the UE A from the UE A. For example, the server may predict the driving path or location of the UE A based on the information included in the first CAM message. In step S620, the server may configure or determine the allowable position error. For example, the allowable position error may be used to compare the difference between the predicted driving path or location of the UE A and the actual driving path or location of the UE A. For example, the allowable position error may be configured or determined based on information related to the state of the server. For example, the value of the allowable position error may be configured or determined to a larger value as the congestion of the DL channel increases. For example, the value of the allowable position error may be configured or determined to a larger value as the number of surrounding UEs of the UE A increases. In step S630, the server may generate a second CAM message based on difference between the predicted driving path or location of the UE A and the actual driving path or location of the UE A exceeds the allowable position error. For example, the second CAM message may include the latest driving information about the UE A. In step S640, the server may transmit the second CAM message to UE B which is another UE located around the UE A. For example, the smaller the value of the allowable position error is configured or determined, the higher the frequency of transmitting the second CAM message to the UE B by the server. For example, the greater the value of the allowable position error is configured or determined, the lower the frequency of transmitting the second CAM message to the UE B by the server.

According to various embodiments of the present disclosure, when transmitting various messages including ITS messages (e.g., CAM, DENM, VAM, BSM, PSM, etc.) through Uu V2X and/or direct communication (e.g., LTE/NR sidelink, ITS-G5, IEEE 802.11p-based short range communication), by predicting the location of the UE at the transmission UE and/or the server/cloud/central ITS station/MEC (Mobile Edge Computing) and generating/transmitting messages only when difference between the predicted location of the UE and the actual location of the UE exceeds the allowable position error level, it is possible to achieve the effect of reducing data traffic (e.g., UL/DL traffic, congestion of UL/DL/SL channels (e.g., CBR), and data traffic in inter-server communication).

According to various embodiments of the present disclosure, the transmission of CAM messages, etc. from the UE to the server is not performed periodically but only when a specific threshold value is exceeded based on location prediction of the UE, thereby preventing unnecessary increases in data traffic in communication between the UE and the server. Furthermore, the specific threshold value may be flexibly configured according to the service required by the UE, the driving state of the UE, or the state of surrounding UEs. In other words, the UE may perform the transmission operation of CAM messages, etc. to the server more efficiently.

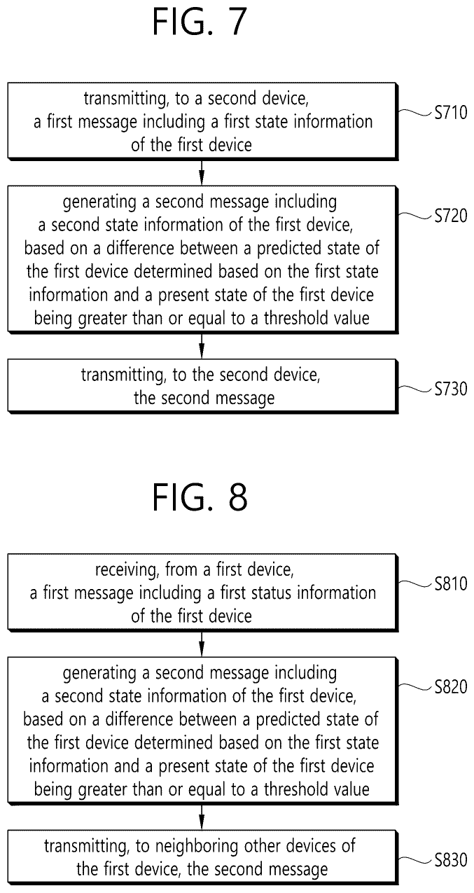

FIG. 7 shows a method for performing wireless communication by a first device, based on an embodiment of the present disclosure. The embodiment of FIG. 7 may be combined with various embodiments of the present disclosure.

Referring to FIG. 7, In step S710, a first device may transmit, to a second device, a first message including a first state information of the first device. In step S720, the first device may generate a second message including a second state information of the first device, based on a difference between a predicted state of the first device determined based on the first state information and a present state of the first device being greater than or equal to a threshold value. In step S730, the first device may transmit, to the second device, the second message. For example, the threshold value may be configured based on at least one of (i) a service of the first device or (ii) a state of the first device.

For example, the higher a relevance of the service of the first device to safety, the smaller the threshold value may be configured.

For example, the higher a relevance of the service of the first device to awareness or warning, the smaller the threshold value may be configured.

For example, the tighter a positioning accuracy requirement related to the service of the first device, the smaller the threshold value may be configured.

For example, the higher a risk level of a zone related to a location of the first device, the smaller the threshold value may be configured.

For example, the tighter a distinction between a driving direction and an opposite driving direction of a road related to the state of the first device, the greater the threshold value may be configured.

For example, the higher a maximum driving speed allowed on a road related to the state of the first device, the smaller the threshold value may be configured.

For example, the higher a velocity or an acceleration related to the state of the first device, the smaller the threshold value may be configured.

For example, wherein the greater a change amount of a direction related the state of the first device, the smaller the threshold value may be configured.

For example, the greater a difference in a driving speed or a driving direction with another device related to the state of the first device, the smaller the threshold value may be configured.

For example, the higher a density with another device related to the state of the first device, the smaller the threshold value may be configured.

For example, the higher a randomness of a driving pattern related to the state of the first device, the smaller the threshold value may be configured.

For example, the lower a remaining power related to the state of the first device, the smaller the threshold value may be configured.

The proposed method may be applied to devices according to various embodiments of the present disclosure. First, a processor 102 of a first device 100 may control a transceiver 106 to transmit, to a second device, a first message including a first state information of the first device. And, the processor 102 of the first device 100 may generate a second message including a second state information of the first device, based on a difference between a predicted state of the first device determined based on the first state information and a present state of the first device being greater than or equal to a threshold value. And, the processor 102 of the first device 100 may the transceiver 106 to transmit, to the second device, the second message. For example, the threshold value may be configured based on at least one of (i) a service of the first device or (ii) a state of the first device.

According to one embodiment of the present disclosure, provided is a first device configured to perform wireless communication. The first device may comprise: at least one transceiver; at least one processor; and at least one memory connected to the at least one processor and storing instructions. For example, the instructions, based on being executed by the at least one processor, cause the first device to perform operations comprising: transmitting, to a second device, a first message including a first state information of the first device; generating a second message including a second state information of the first device, based on a difference between a predicted state of the first device determined based on the first state information and a present state of the first device being greater than or equal to a threshold value; and transmitting, to the second device, the second message. For example, the threshold value may be configured based on at least one of (i) a service of the first device or (ii) a state of the first device.

According to one embodiment of the present disclosure, provided is a processing device configured to control a first device. The processing device may comprise: at least one processor; and at least one memory connected to the at least one processor and storing instructions. For example, the instructions, based on being executed by the at least one processor, cause the first device to perform operations comprising: transmitting, to a second device, a first message including a first state information of the first device; generating a second message including a second state information of the first device, based on a difference between a predicted state of the first device determined based on the first state information and a present state of the first device being greater than or equal to a threshold value; and transmitting, to the second device, the second message. For example, the threshold value may be configured based on at least one of (i) a service of the first device or (ii) a state of the first device.

According to one embodiment of the present disclosure, provided is a non-transitory computer-readable storage medium recording instructions. For example, the instructions, based on being executed, cause a first device to perform operations comprising: transmitting, to a second device, a first message including a first state information of the first device; generating a second message including a second state information of the first device, based on a difference between a predicted state of the first device determined based on the first state information and a present state of the first device being greater than or equal to a threshold value; and transmitting, to the second device, the second message. For example, the threshold value may be configured based on at least one of (i) a service of the first device or (ii) a state of the first device.

FIG. 8 shows a method for performing wireless communication by a second device, based on an embodiment of the present disclosure. The embodiment of FIG. 8 may be combined with various embodiments of the present disclosure.

Referring to FIG. 8, In step S810, a second device may receive, from a first device, a first message including a first state information of the first device. In step S820, the second device may generate a second message including a second state information of the first device, based on a difference between a predicted state of the first device determined based on the first state information and a present state of the first device being greater than or equal to a threshold value. In step S830, the second device may transmit, to neighboring other devices of the first device, the second message. For example, the higher a congestion level of a downlink (DL) channel, the threshold value may be configured.

The proposed method may be applied to devices according to various embodiments of the present disclosure. First, a processor 202 of a second device 200 may control a transceiver 206 to receive, from a first device, a first message including a first state information of the first device. And, the processor 202 of the second device 200 may generate a second message including a second state information of the first device, based on a difference between a predicted state of the first device determined based on the first state information and a present state of the first device being greater than or equal to a threshold value. And, the processor 202 of the second device 200 may control the transceiver 206 to transmit, to neighboring other devices of the first device, the second message. For example, the higher a congestion level of a downlink (DL) channel, the threshold value may be configured.

According to one embodiment of the present disclosure, provided is a second device configured to perform wireless communication. The second device may comprise: at least one transceiver; at least one processor; and at least one memory connected to the at least one processor and storing instructions. For example, the instructions, based on being executed by the at least one processor, cause the second device to perform operations comprising: receiving, from a first device, a first message including a first state information of the first device; generating a second message including a second state information of the first device, based on a difference between a predicted state of the first device determined based on the first state information and a present state of the first device being greater than or equal to a threshold value; and transmitting, to neighboring other devices of the first device, the second message. For example, the higher a congestion level of a downlink (DL) channel, the threshold value may be configured.

According to one embodiment of the present disclosure, provided is a processing device configured to control a second device. The processing device may comprise: at least one processor; and at least one memory connected to the at least one processor and storing instructions. For example, the instructions, based on being executed by the at least one processor, cause the second device to perform operations comprising: receiving, from a first device, a first message including a first state information of the first device; generating a second message including a second state information of the first device, based on a difference between a predicted state of the first device determined based on the first state information and a present state of the first device being greater than or equal to a threshold value; and transmitting, to neighboring other devices of the first device, the second message. For example, the higher a congestion level of a downlink (DL) channel, the threshold value may be configured.

According to one embodiment of the present disclosure, provided is a non-transitory computer-readable storage medium recording instructions. For example, the instructions, based on being executed, cause a second device to perform operations comprising: receiving, from a first device, a first message including a first state information of the first device; generating a second message including a second state information of the first device, based on a difference between a predicted state of the first device determined based on the first state information and a present state of the first device being greater than or equal to a threshold value; and transmitting, to neighboring other devices of the first device, the second message. For example, the higher a congestion level of a downlink (DL) channel, the threshold value may be configured.

Various embodiments of the present disclosure may be combined with each other.

Hereinafter, device(s) to which various embodiments of the present disclosure can be applied will be described.

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

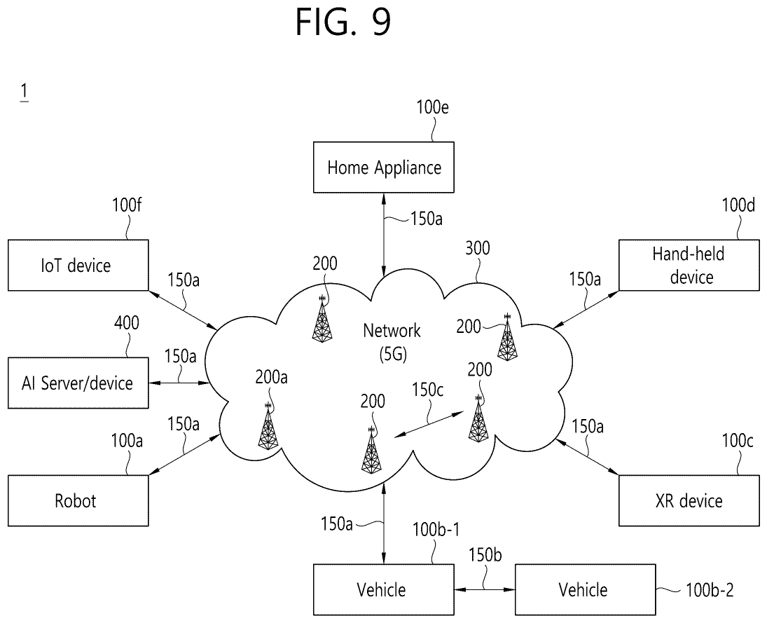

FIG. 9 shows a communication system 1, based on an embodiment of the present disclosure. The embodiment of FIG. 9 may be combined with various embodiments of the present disclosure.

Referring to FIG. 9, a communication system 1 to which various embodiments of the present disclosure are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

Here, wireless communication technology implemented in wireless devices 100a to 100f of the present disclosure may include Narrowband Internet of Things for low-power communication in addition to LTE, NR, and 6G. In this case, for example, NB-IoT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices 100a to 100f of the present disclosure may perform communication based on LTE-M technology. In this case, as an example, the LTE-M technology may be an example of the LPWAN and may be called by various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, and is not limited to the name described above. Additionally or alternatively, the wireless communication technology implemented in the wireless devices 100a to 100f of the present disclosure may include at least one of Bluetooth, Low Power Wide Area Network (LPWAN), and ZigBee considering the low-power communication, and is not limited to the name described above. As an example, the ZigBee technology may generate personal area networks (PAN) related to small/low-power digital communication based on various standards including IEEE 802.15.4, and the like, and may be called by various names.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

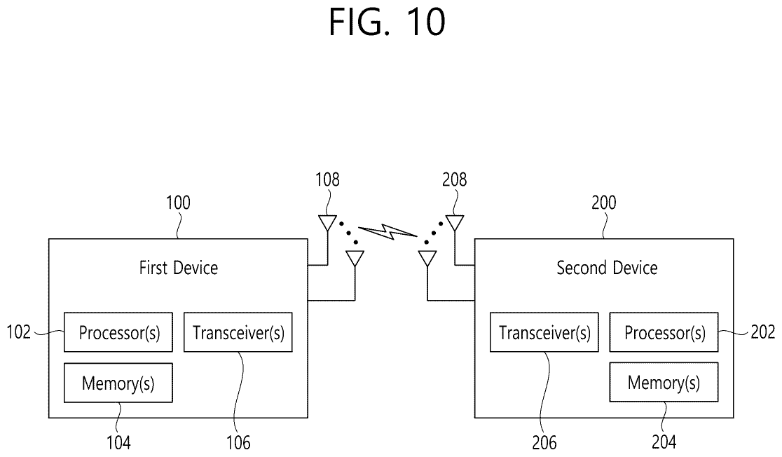

FIG. 10 shows wireless devices, based on an embodiment of the present disclosure. The embodiment of FIG. 10 may be combined with various embodiments of the present disclosure.

Referring to FIG. 10, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 9.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

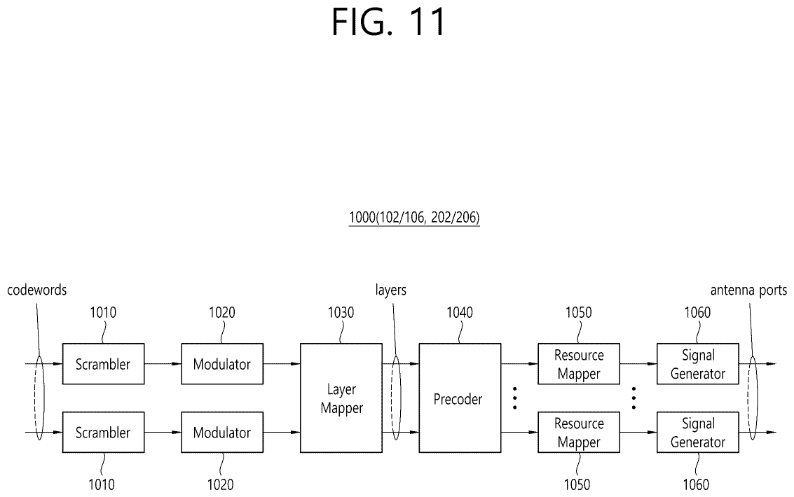

FIG. 11 shows a signal process circuit for a transmission signal, based on an embodiment of the present disclosure. The embodiment of FIG. 11 may be combined with various embodiments of the present disclosure.

Referring to FIG. 11, a signal processing circuit 1000 may include scramblers 1010, modulators 1020, a layer mapper 1030, a precoder 1040, resource mappers 1050, and signal generators 1060. An operation/function of FIG. 11 may be performed, without being limited to, the processors 102 and 202 and/or the transceivers 106 and 206 of FIG. 10. Hardware elements of FIG. 11 may be implemented by the processors 102 and 202 and/or the transceivers 106 and 206 of FIG. 10. For example, blocks 1010 to 1060 may be implemented by the processors 102 and 202 of FIG. 10. Alternatively, the blocks 1010 to 1050 may be implemented by the processors 102 and 202 of FIG. 10 and the block 1060 may be implemented by the transceivers 106 and 206 of FIG. 10.

Codewords may be converted into radio signals via the signal processing circuit 1000 of FIG. 11. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. 11. For example, the wireless devices (e.g., 100 and 200 of FIG. 10) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

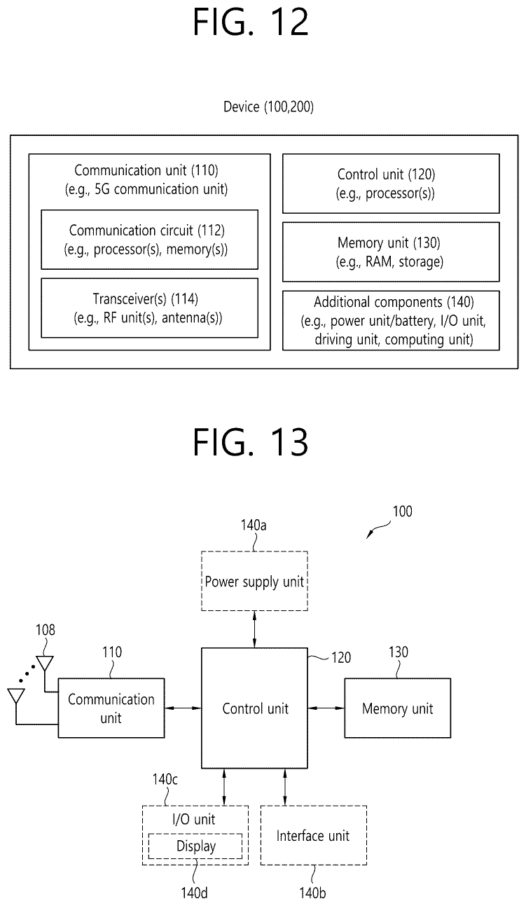

FIG. 12 shows another example of a wireless device, based on an embodiment of the present disclosure. The wireless device may be implemented in various forms according to a use-case/service (refer to FIG. 9). The embodiment of FIG. 12 may be combined with various embodiments of the present disclosure.

Referring to FIG. 12, wireless devices 100 and 200 may correspond to the wireless devices 100 and 200 of FIG. 10 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 10. For example, the transceiver(s) 114 may include the one or more transceivers 106 and 206 and/or the one or more antennas 108 and 208 of FIG. 10. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 9), the vehicles (100b-1 and 100b-2 of FIG. 9), the XR device (100c of FIG. 9), the hand-held device (100d of FIG. 9), the home appliance (100e of FIG. 9), the IoT device (100f of FIG. 9), a digital broadcast terminal, a hologram device, a public safety device, an MTC device, a medicine device, a fintech device (or a finance device), a security device, a climate/environment device, the AI server/device (400 of FIG. 9), the BSs (200 of FIG. 9), a network node, etc. The wireless device may be used in a mobile or fixed place according to a use-example/service.

In FIG. 12, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 12 will be described in detail with reference to the drawings.

FIG. 13 shows a hand-held device, based on an embodiment of the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT). The embodiment of FIG. 13 may be combined with various embodiments of the present disclosure.

Referring to FIG. 13, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 12, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

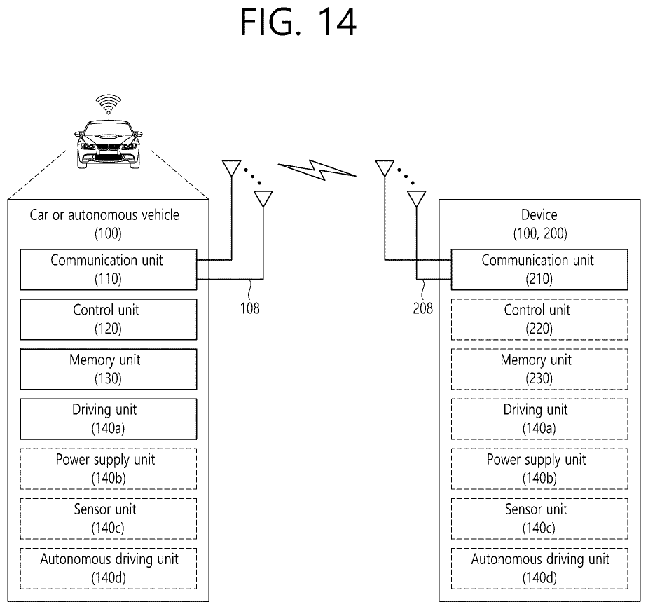

FIG. 14 shows a vehicle or an autonomous vehicle, based on an embodiment of the present disclosure. The vehicle or autonomous vehicle may be implemented by a mobile robot, a car, a train, a manned/unmanned Aerial Vehicle (AV), a ship, etc. The embodiment of FIG. 14 may be combined with various embodiments of the present disclosure.

Referring to FIG. 14, a vehicle or autonomous vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 12, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous vehicle 100. The control unit 120 may include an Electronic Control Unit (ECU). The driving unit 140a may cause the vehicle or the autonomous vehicle 100 to drive on a road. The driving unit 140a may include an engine, a motor, a powertrain, a wheel, a brake, a steering device, etc. The power supply unit 140b may supply power to the vehicle or the autonomous vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous vehicles and provide the predicted traffic information data to the vehicles or the autonomous vehicles.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method.

1. A method for performing wireless communication by a first device, the method comprising:
transmitting, to a second device, a first message including a first state information of the first device;
generating a second message including a second state information of the first device, based on a difference between a predicted state of the first device determined based on the first state information and a present state of the first device being greater than or equal to a threshold value; and
transmitting, to the second device, the second message,
wherein the threshold value is configured based on at least one of (i) a service of the first device or (ii) a state of the first device.

2. The method of claim 1, wherein the higher a relevance of the service of the first device to safety, the smaller the threshold value is configured.

3. The method of claim 1, wherein the higher a relevance of the service of the first device to awareness or warning, the smaller the threshold value is configured.

4. The method of claim 1, wherein the tighter a positioning accuracy requirement related to the service of the first device, the smaller the threshold value is configured.

5. The method of claim 1, wherein the higher a risk level of a zone related to a location of the first device, the smaller the threshold value is configured.

6. The method of claim 1, wherein the tighter a distinction between a driving direction and an opposite driving direction of a road related to the state of the first device, the greater the threshold value is configured.

7. The method of claim 1, wherein the higher a maximum driving speed allowed on a road related to the state of the first device, the smaller the threshold value is configured.

8. The method of claim 1, wherein the higher a velocity or an acceleration related to the state of the first device, the smaller the threshold value is configured.

9. The method of claim 1, wherein the greater a change amount of a direction related the state of the first device, the smaller the threshold value is configured.

10. The method of claim 1, wherein the greater a difference in a driving speed or a driving direction with another device related to the state of the first device, the smaller the threshold value is configured.

11. The method of claim 1, wherein the higher a density with another device related to the state of the first device, the smaller the threshold value is configured.

12. The method of claim 1, wherein the higher a randomness of a driving pattern related to the state of the first device, the smaller the threshold value is configured.

13. The method of claim 1, wherein the lower a remaining power related to the state of the first device, the smaller the threshold value is configured.

14. A first device adapted to perform wireless communication, the first device comprising:
at least one transceiver;
at least one processor; and
at least one memory connected to the at least one processor and storing instructions that, based on being executed, cause the first device to perform operations comprising:
transmitting, to a second device, a first message including a first state information of the first device;
generating a second message including a second state information of the first device, based on a difference between a predicted state of the first device determined based on the first state information and a present state of the first device being greater than or equal to a threshold value; and
transmitting, to the second device, the second message,
wherein the threshold value is configured based on at least one of (i) a service of the first device or (ii) a state of the first device.

15.-20. (canceled)

21. The first device of claim 14, wherein the higher a relevance of the service of the first device to safety, the smaller the threshold value is configured.

22. The first device of claim 14, wherein the higher a relevance of the service of the first device to awareness or warning, the smaller the threshold value is configured.

23. The first device of claim 14, wherein the tighter a positioning accuracy requirement related to the service of the first device, the smaller the threshold value is configured.

24. A processing device adapted to control a first device to perform wireless communication, the processing device comprising:
at least one processor; and
at least one memory connected to the at least one processor and storing instructions that, based on being executed, cause the at least one processor to perform operations comprising:
transmitting, to a second device, a first message including a first state information of the first device;
generating a second message including a second state information of the first device, based on a difference between a predicted state of the first device determined based on the first state information and a present state of the first device being greater than or equal to a threshold value; and
transmitting, to the second device, the second message,
wherein the threshold value is configured based on at least one of (i) a service of the first device or (ii) a state of the first device.

25. The processing device of claim 24, wherein the higher a relevance of the service of the first device to safety, the smaller the threshold value is configured.

26. The processing device of claim 24, wherein the higher a relevance of the service of the first device to awareness or warning, the smaller the threshold value is configured.
